(19) United States
(12) Patent Application Publication
(10) Pub. No.: US 2024/0065430 A1
(43) Pub. Date: Feb. 29, 2024

(54) INTERPROXIMAL BRUSH FLOSS PICK

(71) Applicant: VIRGINIA COMMONWEALTH UNIVERSITY, Richmond, VA (US)

(72) Inventor: Christina B. GORDON, Richmond, VA (US)

(21) Appl. No.: 18/260,658

(22) PCT Filed: Nov. 23, 2021
(86) PCT No.: PCT/US2021/060524

§ 371 Date: Jul. 7, 2023

Related U.S. Application Data
(60) Provisional application No. 63/140,327, filed on Jan. 22, 2021.

(51) Int. Cl. A46B 15/00; A61C 15/04

(52) U.S. Cl. CPC A46B 15/0073; A61C 15/046; A46B 2200/108

(57) ABSTRACT

A combined flossing and interproximal brushing dental device, comprising: a handle having a proximal end and a distal end, wherein the proximal end is configured to be held by a user; a first arm; a second arm; dental floss engaging members positioned at or towards a free end of the first arm and at or towards a free end of the second arm, wherein said first arm and said second arm are spaced apart on the handle and the dental floss engaging members are configured to hold dental floss, extending between the first arm and the second arm; and an interproximal brush forming all or a part of the first arm.

### CROSS-REFERENCE TO RELATED APPLICATIONS

This application claims benefit of United States Provisional Patent Application 63/140,327 filed Jan. 22, 2021.

### BACKGROUND OF THE INVENTION

### Field of the Invention

The invention generally relates to a device for cleaning the spaces between the teeth and the areas around the brackets and under the wire of subjects with braces. In particular, the invention provides a device which combines both flossing and brushing capabilities in a single, easy to use device.

### Description of Related Art

Meticulous oral hygiene is necessary in patients undergoing orthodontic treatment. Current orthodontic oral hygiene devices are effective, but not necessarily convenient or time efficient. Proper oral hygiene while wearing braces includes a regime of brushing with a manual or electric toothbrush, cleansing the areas around the brackets and under the wire with an interproximal brush, and flossing. Oral hygiene compliance varies from patient to patient, with low compliance resulting in detrimental effects to the esthetics and health of the dentition.

Orthodontists strongly recommend the use of interproximal brushes in between the brackets and wires of braces in addition to brushing with a manual or electric toothbrush. Though the interproximal brush technique is simple, the main disadvantage of this device is that it increases the time someone spends on oral hygiene.

Regardless of a patient's orthodontic status, dentists recommend flossing daily. According to the ADA, only 16% of the population flosses every day, and 8% of the population reports that they never floss. Keeping in mind that the majority of orthodontic patients are children and teenagers, flossing compliance could be even lower in these age groups. Flossing is a tedious task but necessary for ideal oral hygiene, and it is increasingly challenging and time consuming in patients undergoing orthodontic treatment. It is important to note that patients with braces are unable to use the traditional string floss. Instead, it is recommended that they use “Superfloss”, a floss that contains both a thick, tufted, wooly segment, intended to be woven in between brackets to facilitate cleansing, and a thin traditional floss-like end that can be wedged in between the teeth. In order to use the Superfloss successfully, a patient with braces must thread the thin floss-like end between the wire, pull the tufted segment between the brackets, and then wedge the floss between the teeth. This task is time consuming, and therefore compliance is low.

Floss picks are easy-to-use and time-efficient flossing devices that are popular alternatives to traditional string floss. However, standard floss picks cannot be used by patients with orthodontic appliances because the width of the inferior arm of the floss pick is too wide to fit in between the teeth and the wire that extends between the brackets.

Orthodontic floss picks, such as DenTek “Braces Clean Floss Picks,” Plackers “Orthopicks,” and the “Platypus Orthodontic Flosser,” are known orthodontic flossing alternatives. While these devices are designed with thinner, plastic arms that fit easily in between the teeth and brace wires, these devices do not permit interproximal brushing.

There is a need in the art for an orthodontic device that permits an orthodontic patient to accomplish interproximal brushing and flossing at the same time.

Issued U.S. Pat. No. 5,857,471 discloses a dental hygiene device for cleaning enlarged embrasures. The device includes a brush portion having a plurality of bristles projecting from a rigid spine opposed ends of which are secured to lengths of flexible filament such as dental floss. A free end of at least one of the filaments may be a stiff pin-like tip useful as a toothpick or in threading the device through gaps between teeth or orthodontic structures. However, the overall design differs from the device of the present invention, e.g. a handle with a bifurcated end, one arm of which is a dental brush, is not disclosed.

Published US patent application 20140007899 teaches a combination toothbrush, flossing device, and toothpick are provided in a single dental device. A first part of the dental device comprises a toothbrush connected to a stem of the first part, and a second part of the dental device comprises a toothpick attached to a first end and a flossing device connected to a second end. The first part and the second part are detachably attached to each other. However, the “brush” is a “toothbrush” and is also attached at an end of the device opposite to the flossing mechanism.

Published US patent application US20190105138A1 teaches a dental cleaning tool that includes a handle and a floss holder. The dental cleaning tool also includes a toothpick formed as one end of the handle. The dental cleaning tool further includes a pivotable dental brush which can be stored or tipped out of the storage position for use. During use, it may be located very close to the floss holder but it does not form one arm of the floss holder.

Published US patent application 20190209277 discloses a dental cleaning tool that includes a handle defining a longitudinal axis of the tool, a floss holder a floss holder having a base and two arms extending from the base in perpendicular relation to the longitudinal axis, at least one strand of floss extending between the two arms, and a pivotable brush attached to the floss holder. The pivotable brush includes a rod and bristles disposed on the rod. The rod is pivotably mounted to the floss holder between a first, stowed position and a second, use position. However, the brush is attached to and extends from an arm of the tool rather than being an arm of the tool.

Published US patent application 20190388201 describes a three-in-one tooth-cleaning device comprising a toothpick, an interdental brush, and a floss pick. The floss pick is positioned at one end and the toothpick is at the opposite end. The interdental elastic-bristle portion is integrally formed over the periphery of the main body in a section adjacent to the second end of the main body. However, the brush unit is not one arm of the flossing unit.

Published US patent application 20200046475 discloses a “kite shaped” brush head, structured for cleaning and stimulating tissues between the teeth, and including multiple of wire bristles with varying length size fanning radially outward from a handle. The opposite end of the device comprises a more or less standard flossing arrangement, e.g. two arms with floss strung between. However, the brush portion and the flossing portion are on opposite ends of the device.

Published US patent application 20200178681 discloses a tooth-cleaning device capable of storing or operatively mounting an interdental brush. The device includes a floss-pick unit and an interdental-brush unit. However, the brush unit is either stored within the device or mounted on an end of the device that is opposite to the floss-pick unit.

Published US patent application 20200345126 describes a combination flossing device and interdental brush. However, the two elements are located at opposite ends of the device.

WO2017035822A1 discloses a dental cleaning tool having a handle which defines a longitudinal axis of the tool and a floss holder having a base and two arms. An angled brush is attached to the floss holder includes a rod and bristles and is oriented at an acute angle relative to one of the arms of the floss holder. However, the brush is attached to and extends from an arm of the tool rather than being an arm of the tool. CN202223372U discloses a combination flossing portion and interdental brush portion, as shown in the figure. However, the flossing portion is separate from interdental brush portion, which appears to be connected to the handle. TW201330831 discloses a combination flossing portion and interdental brush portion, but the two are located on opposite ends of the device.

### SUMMARY OF THE INVENTION

Other features and advantages of the present invention will be set forth in the description of invention that follows, and in part will be apparent from the description or may be learned by practice of the invention. The invention will be realized and attained by the compositions and methods particularly pointed out in the written description and claims hereof.

A compliant orthodontic patient would brush, cleanse with an interproximal brush, and floss daily in three separate steps. The presently disclosed device, the “Proxy-Flosser” allows patients to accomplish interproximal brushing and flossing at the same time (simultaneously), resulting in a two-step oral hygiene routine in a single procedure. The present device thus combines two devices (an interproximal brush, and a floss pick) into one, easy-to-use device. The device provides orthodontic patients with the ability to easily perform two strongly recommended oral hygiene practices that increase cleansing efficiency and while decreasing time spent on good oral hygiene practice.

It is an object of this invention to provide a combined flossing and interproximal brushing dental device, comprising: a handle having a proximal end and a distal end, wherein the proximal end is configured to be held by a user; a first arm extending from the handle from a first point a first distance from the proximal end of the handle towards the distal end of the handle to a free end of the first arm; a second arm extending from the handle from a second point a second distance from the proximal end of the handle at or towards the distal end of the handle to a free end of the second arm, wherein the second distance from the proximal end of the handle is further than the first distance from the proximal end of the handle; dental floss engaging members positioned at or towards the free end of the first arm and at or towards the free end of the second arm, wherein said first arm and said second arm are spaced apart on the handle and the dental floss engaging members are configured to hold dental floss extending between the first arm and the second arm; and an interproximal brush forming all or a part of the first arm. In some aspects, the first arm is disconnectable from the handle. In other aspects, the handle, the first arm, and the second arm are each part of a monolithic integrated structure. In further aspects, the first arm, the second arm, and the handle form a substantially U-shape therebetween. In additional aspects, the first arm and the second arm extend substantially parallel to each other from the first point and the second point of the handle. In some aspects, the combined flossing and interproximal brushing dental device of claim 1 further comprises one or more finger grip regions built into the handle at a distance from the proximal end of the handle that is shorter than the first distance to the first point. In further aspects, the handle has one more openings that extend through the handle. In other aspects, cleaning elements of the interproximal brush are applied to the first arm by over-molding.

The invention also provides a method for simultaneously cleaning an interproximal space between two adjacent teeth and a space between two brackets of an orthodontic device installed on the two adjacent teeth, comprising
i) sliding the interproximal brush of the combined flossing and interproximal brushing dental device of claim 1 between the two brackets and underneath a wire of the orthodontic device, while simultaneously positioning the second arm is of the dental interproximal cleaning device behind the two adjacent teeth so as to wedge the dental floss between the two adjacent teeth; and
ii) moving the device with an oscillating movement to simultaneously clean the interproximal space and the space between the two brackets.

### BRIEF DESCRIPTION OF THE DRAWINGS

FIG. 1. Schematic depiction of one embodiment of the “Proxy-Flosser”. The “Proxy-Flosser” takes the form of a traditional floss pick, but instead of two plastic arms suspending the floss, the lower or inferior (proximal) arm is replaced with an interproximal brush. The floss is thus strung across from the superior (distal) arm to the lower interproximal brush.

FIG. 2. Schematic depiction of an alternative embodiment of the “Proxy-Flosser”. In this embodiment, the brush portion comprises raised flexible nubs or extensions.

FIG. 3. Schematic depiction of another alternative embodiment of the “Proxy-Flosser”. In this embodiment, the brush portion comprises flexible bristles.

FIG. 4. Schematic representation of the brush portion of the device.

FIG. 5. Schematic representation of the proper placement and usage of the device of the invention. The tooth is viewed in profile.

FIG. 6A-C. Views of the placement of the device of the invention during use. A, front view when facing the patient; B, side view; C, second side view.

### DETAILED DESCRIPTION

What is disclosed herein is an “interproximal brush floss pick,” (“Proxy-Flosser”) which combines (has features of both) a traditional interproximal brush (“interdental cleaner”) and a standard floss pick. The end user is typically a subject with braces. This combination allows the user to simultaneously i) floss between teeth and ii) clean between the brackets and wires of an orthodontic appliance using a single device.

The dental interproximal cleaning device disclosed herein comprises i) a proximal handle end and ii) a bifurcated distal end. The bifurcated distal end comprises a first arm and a second arm, both of which extend outward from the same side of the device at approximately 90° angles and are substantially parallel to each other. Dental floss extends between the first arm and the second arm. The first arm is or comprises an interproximal brush.

### The Handle and Arms

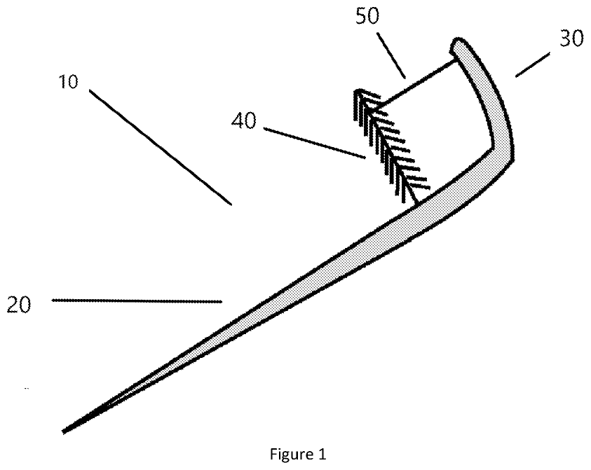

An exemplary device of the invention is illustrated schematically in FIG. 1. What is shown is device 10 comprising handle 20, first arm 40 and second arm 30. First arm 40 and second arm 30 both extend outward from device 10 and dental floss 50 extends therebetween. First arm 40 and second arm 30 and the portion of the device to which they are attached (first and second points of attachment, respectively) make up the “bifurcated distal end” of the device referenced above.

The handle has a proximal end and a distal end, wherein the proximal end is configured to be held by a user. As can be seen in FIG. 1, the first arm extends from the handle from a first point on the handle a first distance from the proximal end of the handle towards the distal end of the handle to a free end of the first arm. The second arm extends from the handle from a second point on the handle a second distance from the proximal end of the handle at or towards the distal end of the handle to a free end of the second arm. The second distance from the proximal end of the handle is further than the first distance from the proximal end of the handle.

The handle portion and the second arm depicted in FIG. 1 may or may not be manufactured as a single integrated piece (monolithic), i.e. a joint may or may not be present at the angle where the second arm extends outward from the device. Typically, the handle portion and the second arm are produced in an integrated fashion, as a single piece but they may also be joined, e.g. using a hot-melt or adhesive method. In some aspects, the handle and the first and second arms are manufactured as a single monolithic piece and the brush portion, discussed in detail below, is made by over-molding.

Materials for producing such handles and arms are known in the art and include, for example: polymers such as polypropylene, polyethylene, acrylonitrile butadiene styrene (ABS) copolymer, or a high-impact polystyrene (HIPS)) etc., e.g. by injection molding. However, other materials are not excluded, for example metals (e.g. stainless steel); wood; etc. The material may be transparent or opaque. In some aspects, the handle and first arm are produced using a biodegradable (e.g. compostable) and/or recyclable polymer(s)/plastics or other material. Generally, the handle and first arm are manufactured as a single molded piece, the brush and floss are (permanently) attached thereafter using methods that are known in the art and the entire device is single-use (disposable).

In some aspects, the interproximal brush is produced by over-molding. Over-molding refers to a plastic manufacturing process where two materials (e.g. plastic or metal) are bonded together. The bonding is usually chemical bonding, but sometimes mechanical bonding is integrated with the chemical bonding. The primary material is called the substrate, and the secondary material, which is molded over the substrate, is called the subsequent. In this aspect of the present invention, the over-molding process creates small, silicone finger-like projections molded over, e.g. a substrate, (e.g. the first arm of the device) made from the polymer material used for manufacturing the handle and second arm of the device. The handle and first and second arms are manufactured as a single piece and the projections are over-molded onto the first arm and serve as the interproximal brush.

In other aspects, the devices of the invention are designed and manufactured as multiuse or reusable devices. In this case, the handle and second arm portion are generally manufactured as a single (monolithic), reusable device, whereas the dental floss is used once and then discarded. In this case, some attachment means (e.g. dental floss engaging members) are present at the points of attachment of the floss to the first arm and the second arm, e.g. grooves, snaps, etc. positioned at or towards the free ends of the first arm and the second arm. After use, the floss is discarded and before a subsequent use, new dental floss is loaded into the device via the dental floss engaging members.

In these aspects, the brush portion may or may not be replaceable. If the brush portion is permanently attached (i.e. is permanently part of the first arm, is not replaceable and is not disconnectable) then rigorous cleaning between uses is required for such reusable devices. If the brush portion is not permanently attached (i.e. is connectable and detachable, e.g. after use) and disposable, then an attachment means (a brush engaging member) is present in or on the handle at the point of attachment to the handle, e.g. a slot, snap-in means, screwing means, hooking means, etc. to secure the first arm/brush to the handle.

Overall, the device is generally substantially flat, having a length ranging from about 5 to about 10 cm and a width ranging from about 1 to 4 cm. The overall surface area of the handle is generally from about 10 to 20 cm 2 and the handle typically has a depth (thickness) of from about 0.2 to about 0.5 cm. The width may (or may not) vary along the length of the device, as described below. The first and second arms of the device are typically about 1.0 to 2.5 cm in length.

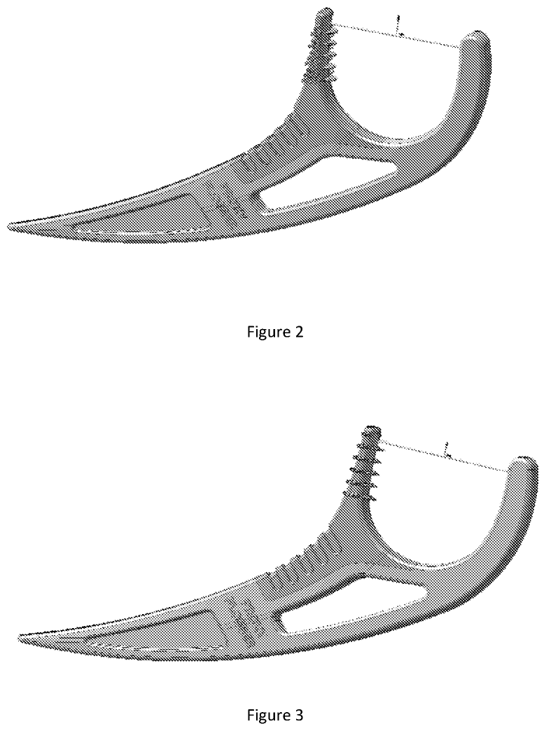

FIGS. 2 and 3 illustrate exemplary aspects of the device. As shown in FIGS. 2 and 3, in these aspects, the width of the handle varies along its length, the handle being wider where it joins the distal bifurcated segment, and then tapering to a point at the proximal end of the handle. Further, in these aspects, the handle is preferably curved. The handle may or may not be curved and/or tapered as shown; handles that are substantially or partly rectangular, and/or which have segments which are substantially or partly rectangular, are also contemplated. It is noted that the handle can take on many shapes and be of many dimensions and sizes. In some aspects, a curved shape is adopted for esthetics and overall appearance of the device.

In other aspects, e.g. as depicted in FIG. 2, the handle portion of the device is curved so that a first edge 102 of the handle is longer than a second edge 103 of the handle, resulting in the curved shape. The lengths of the first and second edges is typically in the range of from about 5 to about 10 cm.

In addition, as shown in FIG. 2, the handle may have one or more “cut-out” regions that form an opening 100 in the surface area of the handle. Opening 100 may be sized and shaped, for example, to accommodate one or more fingers and/or the thumb of the user when placed therein during use to aid in gripping, e.g. having an area of about 2.5 to 10 cm 2, depending on the overall surface area of the handle. Alternatively, the openings may be decorative. However, devices without openings are also encompassed herein.

The device may be of any known color (or may be multicolored) and may include, for example, a design which is printed or embossed on the surface, such as a trade name. The handle may be personalized, e.g. with the patient's name and/or decoratively themed e.g. for holidays, sports, music, cartoon characters, etc. In addition, one or more sections of the device may include decorative reflective material, “glow in the dark” components, etc. that could be appealing to young uses. Grooves or dips may be included in the design. In some aspects, these elements are part of the design. In other aspects, they have a practical function e.g. by forming finger grips, ridges, etc. for easy gripping of the device. The device may be ergonomically designed. Such elements may be molded as part of the handle when manufactured or may be attached after the handle is produced e.g. via an adhesive, hot-melt, etc. In FIG. 2, finger grip 101 is shown.

### Interproximal Brush

The first arm of the device (first arm 40 in FIGS. 1, 2, and 3) is or comprises an interproximal brush. The interproximal brush is designed and sized so as to slide in between the two brackets of two adjacent teeth and underneath the wire that is held by the two brackets.

An interproximal brush generally comprises a support comprising two ends e.g. a first and second end. The support is typically substantially cylindrical; however, other forms are not excluded, e.g. rectangular, ovoid, etc. The first end of the support is attached to and extends out (at approximately a 90° angle) from the handle section of the device. In fact, the support, the handle and the second arm may be manufactured as a single piece. Usually, the attachment is rigid and does not permit flexing at the site of attachment. The second end of the support is configured to receive one end of a length of dental floss. The support may be made of any suitable material which is substantially rigid, examples of which includes but are not limited to wire, rigid polymers (such as those used for manufacturing the handle), etc.

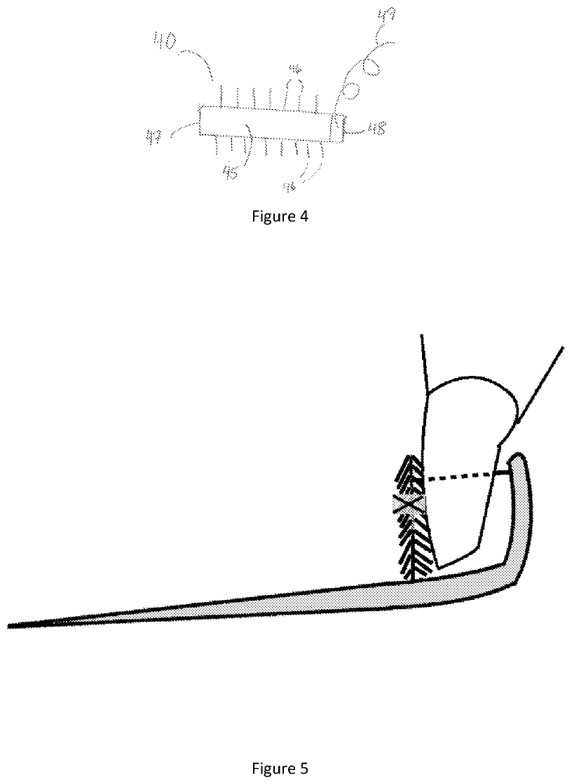

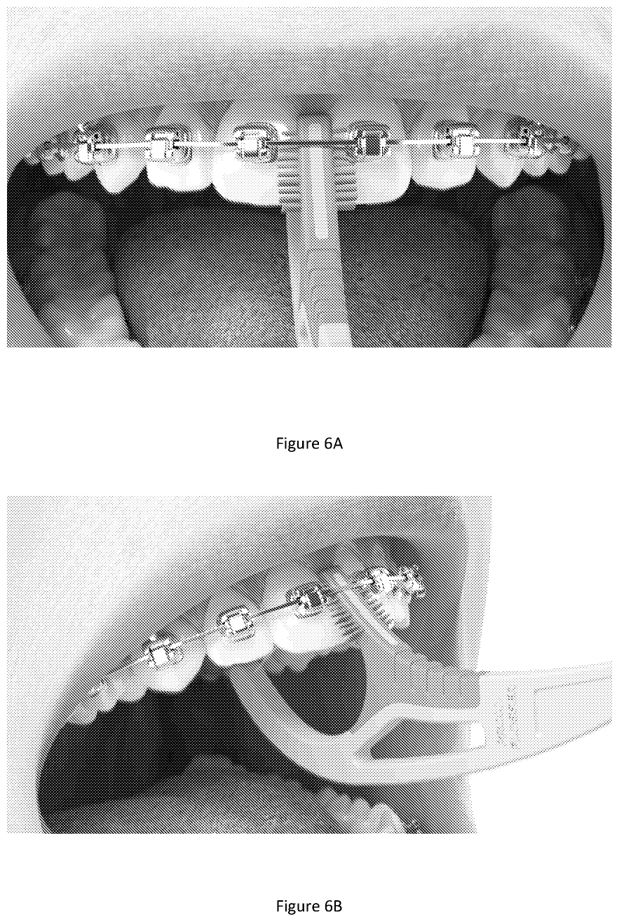

The exterior surface of the support has a plurality of cleaning elements projecting therefrom, i.e. a plurality of cleaning elements protrude/extend outward from the support. FIG. 4 shows interproximal brush 40 comprising support 45 having first end 47 that (attaches to handle 20, see FIG. 1A), second end 48 (that receives an end of a section of dental floss 49). Cleaning elements 46 are shown disposed along the length of support 45. Generally, the cleaning elements protrude from and are present on the entire exterior surface of support 45, e.g. in a spiral or other design around the entire circumference of the support, or as straight or wavy lines running up and down along the long dimension of the support. The cleaning elements may or may not be all the same length. For example, the cleaning elements may be tapered from one end of the support to the other and/or a mix of various sizes and lengths of cleaning elements may be present in a device. In other aspects, some segments or sections of the exterior surface of support 45 do not have cleaning elements extended therefrom, i.e. the exterior surface of support 45 is only partially covered with cleaning elements.

The interproximal brush can be constructed from a variety of materials. In some aspects, the interproximal brush comprises a wire core with nylon filaments. In other aspects, the interproximal brush is constructed using an over-mold technique. In this aspect, the over-mold covers the inferior/first flossing arm and has small silicone (or other suitable, usually flexible, material) finger-like projections that function as an interproximal brush. In some aspects, the over-molding design is preferred as the easiest and most-cost effective way to manufacture the Proxy-Flosser. In other aspects, as described above, the support is the first arm of the device and is made as a monolith which includes the handle and the second arm, the “bristles” being added by over-molding.

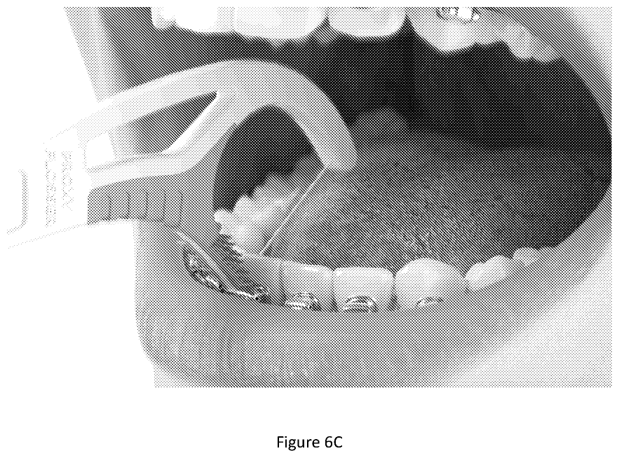

The density of the over-mold projections/brush fingers may vary. There could be patterns of bald spots, or the brush could be very dense without bald spots. As illustrated in the Figures (e.g. see FIGS. 6A-C), in some aspects, there are areas without the brush/finger-like projections, for example, on the lower (proximal) surface of the first (proximal) arm that is positioned closest to the brace during use. The reason there may not be “fingers” on every surface of the brushing arm, particularly the proximal surface of the brushing arm, is for space purposes. There is only a certain amount of space available between the teeth, braces, and wires to brush. However, devices having finger-like projections on every surface are not excluded. For example, the projections on the proximal surface of the proximal arm may be very short so as to allow sufficient space to insert and use the device. FIGS. 2 and 3 show illustrations of two different devices, each of which has a different style of cleaning elements in interproximal brush 40.

In some aspects, the cleaning elements are, for example, classic bristle-like flexible projections. Common examples of such “cleaning elements” include, without limitation, filament bristles, fiber bristles, nylon bristles, spiral bristles, rubber bristles, elastomeric protrusions, flexible polymer protrusions, co-extruded filaments, flag bristles, crimped bristles, anti-bacterial bristles, polybutylene terephthalate (PBT) or other commercial yarns, and combinations thereof and/or structures containing such materials or combinations. In some aspects, the cleaning elements are molded as part of the support itself and are made of the same material but may be more flexible due to being thinner. Further examples are described in e.g. Published US patent application 20200383460, the complete contents of which is herein incorporated by reference in entirety. As discussed elsewhere herein, the cleaning elements may be formed via over-molding.

The cleaning elements may comprise various additives, e.g. active tartar control, anticaries, antiplaque and/or antibacterial actives and/or dentally acceptable agents such as polishing and abrasive agents, coolants, flavorants, waxes, fluoride and/or coagulants.

The brush components may be white or off-white, or of any other color.

The dimensions of the brush may vary according to the teeth of the subject that is the end user. For example, a variety of sizes may be provided for e.g. a tight/narrow, average/medium or wide fit, with respect to the space under a wire and between the brackets of adjacent teeth. For example, the circumference of a brush may be in the range of from about 0.2 to about 0.5 cm, such as about 0.2, 0.3, 0.4 or 0.5 cm.

### Dental Floss

The device comprises a segment of string- or thread-type flexible dental floss attached to and extending between the tips of the first and second arms. The dental floss may be of any known type, and may be made of any suitable material or design, examples of which include but are not limited to: nylon, PTFE (polytetrafluoroethylene), silk, etc. and those described e.g. in published US patent applications 20210145555, the complete contents of which is herein incorporated by reference in entirety. The floss may or may not be flavored. The floss is typically white, but flosses having other colors are also encompassed. The floss may contain active tartar control, anticaries, antiplaque and/or antibacterial actives and/or dentally acceptable agents such as polishing and abrasive agents, coolants, flavorants, waxes, fluoride and/or coagulants.

The length of the dental floss that is attached or accommodated between the two arms is typically from about 1.0 to about 2.5 cm in length, such as about 1.1, 1.2, 1.3, 1.4, 1.5, 1.6, 1.7, 1.8, 1.9, 2.0, 2.1, 2.2, 2.3, 2.4 or 2.5 cm.

### Additional Structures

In some aspects, the proximal end of the handle comprises one or more additional structures for oral cleaning, such as a soft tissue cleanser. Such soft tissue cleansers (such as e.g. a “toothpick” and/or a small brush component for oral hygiene) are typically constructed of a thermoplastic elastomer (TPE) and include one or more projections, such as a point, nubs and/or ridges, for engaging and cleaning between or around teeth. TPEs, sometimes referred to as thermoplastic rubbers, are a class of copolymers or a physical mix of polymers (usually a plastic and a rubber) that comprise materials with both thermoplastic and elastomeric properties.

### Dimensions

As noted above, the device is typically from about 5 to about 10 cm in length, e.g. about 5, 6, 7, 8, 9, or 10 cm, including all decimal fractions in between these integers. The first and second arms of the device are generally the same length, e.g. from about 1.5 to about 2.5 cm in length, such as about 1.5, 1.6, 1.7, 1.8, 1.9, 2.0, 2.1, 2.2, 2.3, 2.4 or 2.5 cm. However, devices in which the lengths of the first and second arms differ, e.g. by about 0.1 to 0.5 cm, are also encompassed. Also as noted above, in some aspects, such as the curved versions of the device, the outer edges of the device may be different lengths, resulting in a curved shape.

Those of skill in the art will recognize that the sizes of devices may vary. Sizes may vary for any reason, e.g. to save on manufacturing costs, to accommodate the size of a patient's mouth/oral cavity, etc. In particular, the handle may be longer that that of a typical floss pick to permit an easy reach into the back of the mouth, whereas shorter handles may be more appropriate for front teeth, and intermediate length handles may be useful for side teeth. The mouths of a young orthodontic patient are typically smaller overall than those of older or adult patients, and the devices of the invention may be sized to accommodate these differences.

### Use of the Device

During use, the interproximal brush is positioned as illustrated in FIG. 5, which shows cleaning between two adjacent upper teeth. Tooth 200 that is shown is the tooth that is closest to the viewer. The second tooth, which would be further from the viewer, is not shown. To use the device with upper teeth, the two arms of the device are positioned upward and the device is inserted into the mouth so that second arm 30 of the device is positioned further back and to the rear of the two adjacent teeth and interproximal brush 40 is positioned in front of the two adjacent teeth. An upward motion causes the brush to insert into the space between the two teeth and under the wire (not shown) that is held in place by two adjacent brackets (for simplicity, only one bracket 201 is shown), while simultaneously floss 50, suspended between the second arm and the brush, is carried into the space between the two adjacent teeth. The device is moved up and down in an oscillating manner to achieve vertical movement of the brush and dental floss at their respective locations: i) the brush in the area directly behind a wire and in front of the space or gap between two adjacent teeth, and also to the sides of this area extending as far as the brush can reach, for example, up to the sides of the two brackets that are present, one of each of the two adjacent teeth; and ii) the floss in between the two adjacent teeth as per the usual positioning of dental floss. In FIG. 5, floss 50 is shown partly in phantom (dashed lines) for the portion of the floss that is behind tooth 200 during flossing. FIGS. 6A and B show a frontal and side view of how the device is positioned, respectively. The process is the same for cleaning lower teeth, except that the device is positioned with the arms downward prior to insertion into the mouth, as shown in FIG. 6C.

Stated differently, the device is positioned by sliding the brush in between the brackets of two adjacent teeth and underneath the wire. Concurrently, the plastic upper arm, is situated behind the posterior surface of the teeth. Once in place, an up and down movement of the device wedges the floss between the teeth, while simultaneously moving the interproximal brush up and down, thereby i) flossing between the two adjacent teeth; and ii) brushing the area under the wire and directly in front of the space between the two adjacent teeth.

It is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Representative illustrative methods and materials are herein described; methods and materials similar or equivalent to those described herein can also be used in the practice or testing of the present invention.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual dates of public availability and may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as support for the recitation in the claims of such exclusive terminology as “solely,” “only” and the like in connection with the recitation of claim elements, or use of a “negative” limitations, such as “wherein [a particular feature or element] is absent”, or “except for [a particular feature or element]”, or “wherein [a particular feature or element] is not present (included, etc.) . . . ”.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

The invention is further described by the following non-limiting examples which further illustrate the invention, and are not intended, nor should they be interpreted to, limit the scope of the invention.

While the invention has been described in terms of its several exemplary embodiments, those skilled in the art will recognize that the invention can be practiced with modification within the spirit and scope of the appended claims. Accordingly, the present invention should not be limited to the embodiments as described above but should further include all modifications and equivalents thereof within the spirit and scope of the description provided herein.

1. A combined flossing and interproximal brushing dental device, comprising:
a handle having a proximal end and a distal end, wherein the proximal end is configured to be held by a user;
a first arm extending from a first point on the handle to a free end, wherein the first point is a first distance from the proximal end of the handle towards the distal end of the handle;
a second arm extending from a second point on the handle to a free end, wherein the second point is a second distance from the proximal end of the handle at or towards the distal end of the handle, wherein the second distance from the proximal end of the handle is further than the first distance from the proximal end of the handle;
dental floss engaging members positioned at or towards the free end of the first arm and at or towards the free end of the second arm, wherein said first arm and said second arm are spaced apart on the handle and the dental floss engaging members are configured to hold dental floss extending between the first arm and the second arm; and
an interproximal brush forming all or a part of the first arm.

2. The combined flossing and interproximal brushing dental device of claim 1 wherein the first arm is disconnectable from the handle.

3. The combined flossing and interproximal brushing dental device of claim 1 wherein the handle, the first arm, and the second arm are each part of a monolithic integrated structure.

4. The combined flossing and interproximal brushing dental device of claim 1 wherein the first arm, the second arm, and the handle form a substantially U-shape therebetween.

5. The combined flossing and interproximal brushing dental device of claim 1 wherein the first arm and the second arm extend substantially parallel to each other from the first point and the second point of the handle.

6. The combined flossing and interproximal brushing dental device of claim 1 further comprising one or more finger grip regions built into the handle at a distance from the proximal end of the handle that is shorter than the first distance to the first point.

7. The combined flossing and interproximal brushing dental device of claim 1, wherein said handle has one more openings that extend through the handle from a first side of the handle to a second side of the handle.

8. The combined flossing and interproximal brushing dental device of claim 1,
wherein cleaning elements of the interproximal brush are applied to the first arm.

9. A method for simultaneously cleaning an interproximal space between two adjacent teeth and a space between two brackets of an orthodontic device installed on the two adjacent teeth, comprising
i) sliding the interproximal brush of the combined flossing and interproximal brushing dental device of claim 1 between the two brackets and underneath a wire of the orthodontic device, while simultaneously positioning the second arm of the dental interproximal cleaning device behind the two adjacent teeth so as to wedge the dental floss between the two adjacent teeth; and
ii) moving the device with an oscillating movement to simultaneously clean the interproximal space and the space between the two brackets.
